(19) United States
(12) Patent Application Publication
(10) Pub. No.: US 2024/0204353 A1
(43) Pub. Date: Jun. 20, 2024

(54) Slurry for a separator, a separator and a preparation method thereof

(71) Applicant: Microvast Advanced Membrane Inc., Lake Mary, FL (US)

(72) Inventors: Jinbo HE, Lake Mary, FL (US); Jianhai LUO, Huzhou (CN)

(21) Appl. No.: 18/537,851

(22) Filed: Dec. 13, 2023

Related U.S. Application Data
(60) Provisional application No. 63/433,039, filed on Dec. 16, 2022.

(51) Int. Cl. H01M 50/423; H01M 50/403; H01M 50/437; H01M 50/44; H01M 50/443

(52) U.S. Cl. CPC H01M 50/423; H01M 50/403; H01M 50/437; H01M 50/44; H01M 50/443

(57) ABSTRACT

A slurry for a separator includes an aromatic polyamide, a solvent, and an additive including a hydrophilic nanofiber. On the one hand, the hydrophilic nanofiber increases the internal tension of the slurry, thereby increasing the mechanical strength of the final separator. On the other hand, the additive in this disclosure can significantly increase the rotational viscosity of the slurry for a separator, which can further reduce the mass fraction of aramid in the slurry while meeting the lowest requirements of rotational viscosity in casting the separator, If the mass fraction of aramid decreases, the mass fraction of solvent increases, and the porosity of the separator obtained by non-solvent induced phase separation (NIPS) increases. Therefore, the separator made using the additive in this disclosure can obtain both high porosity and high mechanical strength, thereby improving the cycle life and safety performance of a lithium battery.

### TECHNICAL FIELD

The present disclosure relates to the technical field of a lithium battery separator, in particular to a slurry for a separator, a separator and a preparation method thereof.

### BACKGROUND

As an important component in batteries, the requirements for high temperature resistance and electrochemical stability of a separator are increasing, aromatic polyamide separators have become the preferred choice for power battery separators due to their excellent high temperature resistance and electrochemical stability, separators with high porosity can improve the liquid absorption rate and liquid retention rate of batteries, greatly enhancing the cycle performance of batteries, therefore, improving the porosity of aromatic polyamide separators has become a goal pursued by those skilled in the art. At present, the aromatic polyamide separators are mainly prepared by non-solvent induced phase separation (NIPS) method, the porosity of the aromatic polyamide separators is positively correlated with the solvent content in the slurry, the higher the solvent content, the higher the porosity of the separator prepared by non-solvent induced phase separation (NIPS) method, however, too high porosity of a separator may lead to a decrease in its mechanical strength, and a separator with a low mechanical strength has poor safety. Therefore, how to balance the high porosity and high mechanical strength of the separator remains a problem in the prior art.

### SUMMARY

The main object of the present disclosure is to provide a slurry for a separator, a separator and a preparation method thereof, so as to solve the problems of short lifespan and poor safety of lithium batteries which is due to the mutual influence between the porosity and mechanical strength of the separator in the prior art makes it difficult to balance high porosity and high mechanical strength of the separator.

In order to achieve the above object, according to one aspect of the present disclosure, a slurry for a separator is provided, which includes an aromatic polyamide, a solvent, and an additive including a hydrophilic nanofiber.

As an embodiment, the slurry for a separator described above includes 10 wt % to 20 wt % of the aromatic polyamide and 80 wt % to 90 wt % of the solvent, in terms of percentage by weight.

As an embodiment, the slurry for a separator described above includes 10 wt % to 15 wt % of the aromatic polyamide and 85 wt % to 90 wt % of the solvent.

As an embodiment, the mass of the hydrophilic nanofiber described above is 0.1 wt % to 20 wt % of the aromatic polyamide.

As an embodiment, the mass of the hydrophilic nanofiber described above is 5 wt % to 20 wt % of the aromatic polyamide.

As an embodiment, the hydrophilic nanofiber described above is selected from the group consisting of any one or more of a cellulose nanofiber, a ceramic nanofiber, or a glass nanofiber.

As an embodiment, the cellulose nanofiber described above includes a carboxymethyl cellulose nanofiber.

As an embodiment, the ceramic nanofiber described above is selected from the group consisting of any one or more of an aluminum silicate fiber, a polycrystalline alumina fiber, or a polycrystalline zirconia fiber.

As an embodiment, the additive described above further includes a hydrophilic nanoparticle with a mass ratio of the hydrophilic nanofiber to the hydrophilic nanoparticle being 1:10 to 10:1.

As an embodiment, the mass ratio of the hydrophilic nanofiber to the hydrophilic nanoparticle described above is 1:2 to 2:1.

As an embodiment, the hydrophilic nanoparticle described above is a flaked silicate and/or gamma alumina powder.

As an embodiment, the flaked silicate described above includes a nano laponite.

As an embodiment, the aromatic polyamide described above is meta-aramid and/or para-aramid.

As an embodiment, the solvent described above is selected from the group consisting of any one or more of N-methylpyrrolidone, N,N-dimethylacetamide, N,N-dimethylformamide, dimethyl sulfoxide, and triethyl phosphate.

As an embodiment, the rotational viscosity of the slurry for a separator described above is from 100, 000 cp to 500, 000 cp.

As an embodiment, the rotational viscosity of the slurry for a separator described above is from 140, 000 cp to 250, 000 cp.

According to another aspect of the disclosure, a preparation method for a separator is provided, which includes extruding the slurry into a liquid membrane, and sending the liquid membrane into a gelation bath through a conveyor to form a membrane, with the liquid membrane contacted with the conveyor along both sides of the conveying direction; extracting the solvent from the membrane through a gelation bath to form a porous membrane; wherein the slurry is selected from the slurry for a separator described above.

According to another aspect of the disclosure, a separator obtained by the aforementioned preparation method is provided, wherein the porosity of the separator is 30% to 90%, preferably 75% to 85%.

As an embodiment, the tensile strength of the separator described above is from 25 MPa to 85 MPa.

According to yet another aspect of the disclosure, a lithium ion battery is provided, including a separator, which is the separator described above.

By applying the technical solution of the present disclosure, an additive hydrophilic nanofiber is added to the slurry for a separator, the hydrophilic nanofiber interacts with the aromatic polyamide polymer to form a network-like structure, the interaction between the hydrophilic nanofiber and the aromatic polyamide polymer includes physical and chemical interactions, wherein the physical interaction is manifested as interattraction between positively and negatively charged functional groups, and the chemical interaction is manifested as the formation of hydrogen bonds between molecules. In one aspect, the hydrophilic nanofiber increases the internal tension of the slurry, thereby increasing the mechanical strength of the final separator. On the other hand, the use of the additive in this disclosure can significantly increase the rotational viscosity of the slurry for a separator, which can further reduce the mass fraction of aramid in the slurry while meeting the basic requirements for rotational viscosity in the membrane casting process of the separator. If the mass fraction of aramid decreases, the mass fraction of solvent increases, and the porosity of the separator obtained by non-solvent induced phase separation (NIPS) increases. Therefore, the separator made using the additive in this disclosure can balance high porosity and high mechanical strength, high porosity can further improve the liquid absorption rate and liquid retention rate of the separator, enhancing the cycle life of lithium batteries, while high mechanical strength (characterized by tensile strength) can prevent lithium dendrites from piercing the separator, improving the safety performance of the batteries.

In addition, the addition of a hydrophilic nanofiber can increase the internal tension of aromatic polyamide solutions, so that when the slurry for a separator is extruded and cast, through the conveyor into the gelation bath, the upper and lower surfaces can both remain hanged, resulting in a consistent thickness throughout the liquid membrane, and a more uniform pore distribution formed in the process of the gelation bath, and thus the obtained separator is more stable during use.

### BRIEF DESCRIPTION OF THE DRAWINGS

The accompanying drawings of the description, which form a part of the disclosure, are used to provide a further understanding of the disclosure. The illustrative embodiments and their descriptions of the disclosure are used to explain the disclosure, and do not constitute an improper limitation thereto. In the accompanying drawings:

FIG. 1 shows an SEM image of a separator provided according to Embodiment 1 of this disclosure;

FIG. 2 shows a flowchart for preparation of a separator provided according to Embodiment 1 of this disclosure.

Wherein, the above accompanying drawings include the following reference symbols:

1. Die head; 2. Gel tank; 3. Conveyor belt; 4. Extraction tank; 5. Dryer; 6. Setting box; 7. Winder.

### DETAILED DESCRIPTION OF THE EMBODIMENTS

It should be noted that the Embodiments and features in the Embodiments in the disclosure can be combined with each other without conflicting. The disclosure will be described in detail below with reference to the drawings and in combination with Embodiments.

As set forth in the background art of this disclosure, there are problems of low porosity and low mechanical strength of separators in the prior art, which lead to short lifespan and poor safety performance of lithium batteries. In order to solve such problems, this disclosure provides a slurry for a separator, a separator and a preparation method thereof, which can achieve excellent porosity and high mechanical strength of separators while ensuring membrane formation.

In a typical embodiment of this disclosure, a slurry for a separator is provided, which includes an aromatic polyamide, a solvent, and an additive including a hydrophilic nanofiber.

An additive hydrophilic nanofiber is added to the slurry for a separator, the hydrophilic nanofiber interacts with the aromatic polyamide polymer to form a network-like structure, the interaction between the hydrophilic nanofiber and the aromatic polyamide polymer includes physical and chemical interactions, wherein the physical interaction is manifested as interattraction between positively and negatively charged functional groups, and the chemical interaction is manifested as the formation of hydrogen bonds between molecules. In one aspect, the hydrophilic nanofiber increases the internal tension of the slurry, thereby increasing the mechanical strength of the final separator. On the other hand, the use of the additive in this disclosure can significantly increase the rotational viscosity of the slurry for a separator, which can further reduce the mass fraction of aramid in the slurry while meeting the lowest requirements of rotational viscosity in the membrane casting process of the separator. If the mass fraction of aramid decreases, the mass fraction of solvent increases, and the porosity of the separator obtained by non-solvent induced phase separation (NIPS) increases. Therefore, the separator made using the additive in this disclosure can obtain high porosity and high mechanical strength, high porosity can further improve the liquid absorption rate and liquid retention rate of the separator, enhancing the cycle life of lithium batteries, while high mechanical strength (characterized by tensile strength) can prevent lithium dendrites from piercing the separator, improving the safety performance of the batteries.

In addition, the addition of a hydrophilic nanofiber can increase the internal tension of aromatic polyamide solutions, so that when the slurry for a separator is extruded, and then cast through the conveyor into the gelation bath, the upper and lower surfaces can both remain hanged, resulting in a consistent thickness throughout the liquid membrane, and a more uniform pore distribution formed in the process of the gelation bath, and thus the obtained separator is more stable during use.

In one embodiment of this disclosure, the slurry for a separator described above includes 10 wt % to 20 wt % of the aromatic polyamide and 80 wt % to 90 wt % of the solvent, in terms of percentage by weight.

When the mass fraction of aromatic polyamide in the slurry for a separator is less than 10%, the mechanical strength of the separator is not ideal due to the lack of basic structural support of aromatic polyamide. Even if an additive is added to the slurry, the mechanical strength of the separator cannot be significantly improved, therefore it is preferably limited that at least 10 wt % of aromatic polyamide is included in the slurry. When the mass fraction of aromatic polyamide in the slurry is higher than 20%, the porosity of the separator is decreased due to the high solid content of the slurry for a separator, the addition of an additive at this point will have an opposite effect on improving the porosity instead. Therefore, in order to balance the mechanical strength and the porosity of the separator, the content of aromatic polyamide is preferably within the range described above.

In order to further enhance the synergistic effect between aromatic polyamide and solvent, and to better balance the high porosity and high mechanical strength of the separator during later membrane casting, in some embodiments of this disclosure, preferably, the slurry for a separator described above includes 10 wt % to 15 wt % of aromatic polyamide and 85 wt % to 90 wt % of solvent.

In one embodiment of this disclosure, the mass of the hydrophilic nanofiber described above is 0.1 wt % to 20 wt % of the aromatic polyamide;

The addition of a hydrophilic nanofiber can help to reduce the mass percentage content of aromatic polyamide appropriately on the premise of membrane formation.

In order to further enhance the above synergistic effects between the hydrophilic nanofiber and the aromatic polyamide, in some embodiments of this disclosure, preferably, the mass of the aforementioned hydrophilic nanofiber is 5 wt % to 20 wt % of the aromatic polyamide, at the same time, based on cost considerations, the amount of additive added can be appropriately reduced within the preferred range.

In one embodiment of this disclosure, the hydrophilic nanofiber described above is selected from the group consisting of any one or more of a cellulose nanofiber, a ceramic nanofiber, or a glass nanofiber.

Preferably, the hydrophilic nanofibers of the above types will help to exert their synergistic effect with the aromatic polyamides, so that the formed network-like structure is more conducive to increasing the rotational viscosity of the slurry for a separator and further enhancing the mechanical strength of the obtained separator.

In one embodiment of this disclosure, preferably, the cellulose nanofiber described above includes a carboxymethyl cellulose nanofiber.

In one embodiment of this disclosure, preferably, the ceramic nanofiber described above is selected from the group consisting of any one or more of an aluminum silicate fiber, a polycrystalline alumina fiber, or a polycrystalline zirconia fiber.

In one embodiment of this disclosure, the additive described above further includes a hydrophilic nanoparticle with a mass ratio of the hydrophilic nanofiber to the hydrophilic nanoparticle being 1:10 to 10:1.

The surface charges of the hydrophilic nanoparticles repel to each other, resulting in the actual volume occupied by the hydrophilic nanoparticles in the slurry to be greater than their own volume, thereby serving as physical cross-linking points. Hydrophilic nanofiber can thicken the slurry and act as the backbone for physical cross-linking inside the slurry. Preferably, the mass ratio between the hydrophilic nanofiber and the hydrophilic nanoparticles is controlled within the above range, which is more conducive to the synergistic effect therebetween, thus forming a synergistic and complementary effect between the hydrophilic nanofiber and the hydrophilic nanoparticles, which helps to balance the high mechanical strength and the high porosity of the separator at the same time.

In addition, when the slurry for a separator is in a static state, hydrophilic nanoparticles and the hydrophilic fiber form a physical cross-linking structure (where the physical cross-linking is a network-like cross-linking structure caused by the attraction between numerous positively and negatively charged functional groups), which helps to maintain the internal structure of the slurry for a separator, prevent the occurrence of sedimentation and layering, and thereby improving the storage stability of the slurry for a separator.

In one embodiment of this disclosure, preferably, the mass ratio of the hydrophilic nanofiber to the hydrophilic nanoparticles is 1:2 to 2:1, which is more conducive to balancing the high mechanical strength and the high porosity of the separator, and thus improving the cycle performance of the batteries made by such separator.

In one embodiment of this disclosure, preferably, the hydrophilic nanoparticle described above is a flaked silicate and/or gamma alumina powder.

In one embodiment of this disclosure, preferably, the flaked silicate described above includes a nano laponite.

In one embodiment of this disclosure, preferably, the solvent described above is selected from the group consisting of any one or more of N-methylpyrrolidone, N,N-dimethylacetamide, N,N-dimethylformamide, dimethyl sulfoxide, and triethyl phosphate, so that the aromatic polyamide can have excellent solvability therein, which is beneficial for improving the uniformity of membrane formation.

In one embodiment of this disclosure, preferably, the rotational viscosity of the slurry for a separator described above is from 100, 000 cp to 500, 000 cp, so that the rotational viscosity required for membrane formation can be met when minimizing the content of aromatic polyamide in the slurry for a separator as much as possible, which makes the membrane more uniform and the membrane formation process easier.

In some embodiments of this disclosure, preferably, the rotational viscosity of the slurry for a separator described above is from 140, 000 cp to 250, 000 cp, thereby helping to make the membrane more uniform as much as possible.

In another typical embodiment of this disclosure, a preparation method for a separator is provided, which includes extruding the slurry into a liquid membrane, and sending the liquid membrane into a gelation bath through a conveyor to form a membrane, with the liquid membrane come into contact with the conveyor along both sides of the conveying direction; extracting the solvent from the liquid membrane through a gelation bath to form a porous membrane; wherein the slurry is selected from the slurry for a separator described above. With the liquid membrane come into contact with the conveyor along both sides of the conveying direction, means that the conveyor contact with opposite widthwise edges of the liquid membrane, while the other portion of the liquid membrane is not in contact with the conveyor, the liquid membrane is kept on the conveyor by a contact force generated between the widthwise edges of the liquid membrane and the carrier unit.

According to the present disclosure, non-solvent induced phase separation (NIPS) is used to prepare the separator, including extruding the slurry for a separator through a die head to form a liquid membrane-like substance (abbreviated as liquid membrane), casting the liquid membrane to the load-bearing component, then entering into the gelation solution, and forming a porous membrane through liquid-liquid phase separation. During the conveying process, only the two edges of the liquid membrane along the conveying direction always remain contact with the load-bearing component. and the rest parts of the liquid membrane do not contact with the load-bearing component.

In order to better utilize the aforementioned slurry for a separator in this disclosure for membrane formation, it is preferred that the solvent in the gelation bath can be either a poor solvent for polyamide or a mixed solvent of a poor solvent and a good solvent for polyamide. Among them, the poor solvent is selected from the group consisting of any one or more of water, ethanol, or dichloromethane; good solvent is selected from the group consisting of any one or more of DMAC, NMP, DMSO, or DMF; and the mixing ratio of poor solvent to good solvent is 10:90 to 50:50, and further preferably 20:80 to 40:60. The temperature of the gelation bath is from −20° C. to 60° C., preferably from 10° C. to 40° C.; and the duration of the gelation bath is from 10 seconds to 10 minutes, preferably from 1 minute to 5 minutes. The porous membrane is washed with deionized water and then dried, with a drying temperature of 50° C. to 150° C., preferably 80° C. to 120° C., and a drying time of 5 minutes to 60 minutes, preferably 10 minutes to 30 minutes.

The aromatic polyamide is dissolved in a solvent to obtain a solution of aromatic polyamide with a certain solid content; an additive is added to the aromatic polyamide solution and mixed under stirring to obtain the aforementioned slurry for a separator, with a stirring speed of 200 r/min to 600 r/min and a stirring time of 4 hours to 16 hours, preferably 8 hours to 12 hours.

The specific conveying method of the above liquid membrane can be found in the Chinese patent disclosure with patent number CN111224042A, which will not be repeated here.

In yet another typical embodiment of this disclosure, a separator obtained by the aforementioned preparation method is provided, wherein the porosity of the separator is 30% to 90%, preferably 75% to 85%.

Through the aforementioned preparation method, due to the effect of the additive, the porosity range of the obtained separator is wider, thereby expanding the application scenarios of the separator. Preferably, the porosity of the aforementioned separator is 75% to 85%, which is more conducive to improving the liquid absorption rate and liquid retention rate of the separator and enhancing the cycle life of the lithium batteries.

In one embodiment of this disclosure, the tensile strength of the aforementioned separator is 25 MPa to 85 MPa.

Benefiting from the stronger interaction between the additive and the aromatic polyamide, the tensile strength of the aforementioned separator is also improved, which helps to improve the safety of the battery cell.

In yet another typical embodiment of this disclosure, a lithium ion battery is provided, including a separator, which is the separator described above.

The lithium ion battery including the aforementioned separator of this disclosure has better cycle life and safety performance.

The beneficial effect of this disclosure will be further explained below in combination with the Embodiments.

### Embodiment 1

50 g of meta aramid was dissolved in 450 g of DMAC to form a solution of meta aramid in DMAC with a solid content of 10%, the rotational viscosity at this point was measured to be 118,000 cp with a viscometer, 0.5 g of carboxymethyl cellulose nanofiber powder was added to the solution and then stirred at room temperature for 8 hours to disperse the powder in the solution so as to obtain a slurry, and the rotational viscosity of the slurry was measured to be 144,200 cp. The slurry was extruded, and then cast into a gelation bath to form a membrane. Specifically, the slurry was extruded through a die head to form a liquid membrane with a width of 60 cm for the liquid membrane, two edges of the liquid membrane were made into contact with the teflon conveyor chain, with a width of 7.5 cm for teflon conveyor chain and a width of 2.5 cm for the liquid membrane part come into contact with the conveyor chain. The conveyor chain was driven into the gelation bath by a gear conveyor belt for gel precipitation. The temperature of the gelation bath was 10° C., the gelling time was 3 minutes, and the mass percentage of water in the gelation bath was 25%.

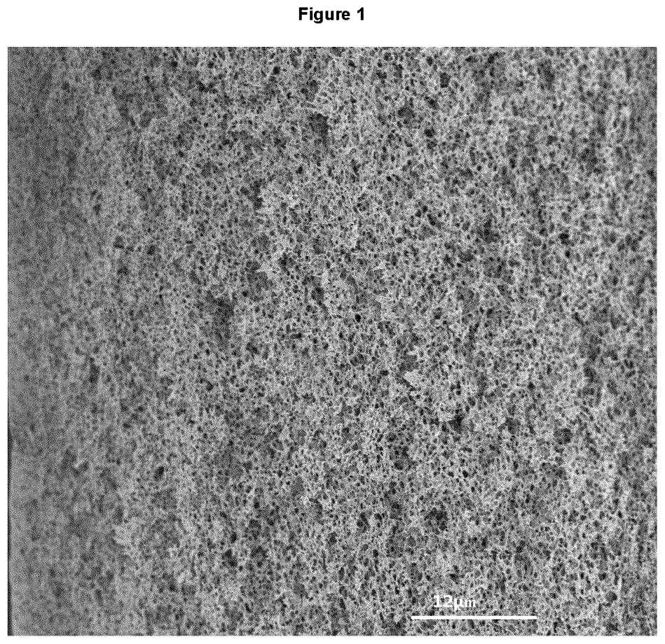

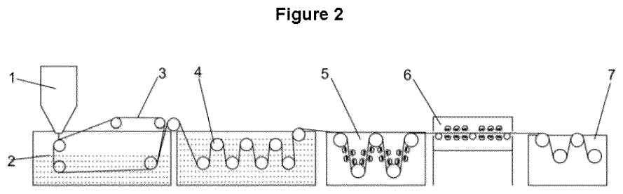

Next, the above membrane was fed into the extraction tank through a conveyor chain, and the solvent was extracted with water to form a porous separator, the temperature of the extraction tank was 40° C. The porous separator was subjected to forced air drying at a drying temperature of 60° C., and finally sent to a high-temperature setting box at a setting temperature of 250° C. After the static electricity was eliminated, the winding was completed to obtain an aromatic polyamide porous separator, which was washed with clean water and dried at 80° C. A separator with 5 cm in length, 5 cm in width, and 16 μm in thickness was taken and used as the sample, and the sample was measured to have a volume (V) of 4×10⁻² cm³, and a weight (W) of 1.38×10⁻² g, which were put into equation to calculate that the porosity (P) of the separator was 75%, and the tensile strength of the separator was measured to be 28 MPa. The SEM image of the separator is shown in FIG. 1, and the flowchart for preparation of the separator is shown in FIG. 2, wherein the tools for membrane preparation used in the preparation flowchart included die head 1, gel tank 2, conveyor belt 3, extraction tank 4, dryer 5, setting box 6, and winder 7.

### Embodiment 2

50 g of meta aramid was dissolved in 450 g of NMP to form a solution of meta aramid in NMP with a solid content of 10%, the rotational viscosity of which was measured to be 122,000 cp with a viscometer, 1.0 g of carboxymethyl cellulose nanofiber powder was added to this solution and then stirred at room temperature for 8 hours to disperse the powder in the solution so as to obtain a slurry, and the rotational viscosity of the slurry was measured to be 145,200 cp. The slurry was extruded, and then cast into a gelation bath to form a membrane. Specifically, the slurry was extruded through a die head to form a liquid membrane with a width of 60 cm for the liquid membrane, two edges of the liquid membrane were made into contact with the teflon conveyor chain, with a width of 7.5 cm for teflon conveyor chain and a width of 2.5 cm for the liquid membrane part come into contact with the conveyor chain. The conveyor chain was driven into the gelation bath by a gear conveyor belt for gel precipitation. The temperature of the gelation bath was 10° C., the gelling time was 3 minutes, and the mass percentage of water in the gelation bath was 25%. Next, the above membrane was fed into the extraction tank through a conveyor chain, and the solvent was extracted with water to form a porous separator, the temperature of the extraction tank was 40° C. The porous separator was subjected to forced air drying at a drying temperature of 60° C., and finally sent to a high-temperature setting box at a setting temperature of 250° C. After the static electricity was eliminated, the winding was completed to obtain an aromatic polyamide porous separator, which was washed with clean water and dried at 80° C. A separator with 5 cm in length, 5 cm in width, and 16 μm in thickness was taken for measurement, and the sample was measured to have a volume (V) of 4×10⁻² cm³, and the weight of the separator was measured to be 0.0121 g, which were put into equation to calculate that the porosity (P) of the separator was 78%, and the tensile strength of the separator was measured to be 30 MPa.

### Embodiment 3

50 g of meta aramid was dissolved in 450 g of DMAC to form a solution of meta aramid in DMAC with a solid content of 10%, the rotational viscosity at this point was measured to be 117,500 cp with a viscometer, 5.0 g of carboxymethyl cellulose nanofiber powder was added to the solution and then stirred at room temperature for 8 hours to disperse the powder in the solution so as to obtain a slurry, and the rotational viscosity of the slurry was measured to be 159,700 cp. The slurry was extruded, and then cast into a gelation bath to form a membrane. Specifically, the slurry was extruded through a die head to form a liquid membrane with a width of 60 cm for the liquid membrane, two edges of the liquid membrane were made into contact with the teflon conveyor chain, with a width of 7.5 cm for teflon conveyor chain and a width of 2.5 cm for the liquid membrane part come into contact with the conveyor chain. The conveyor chain was driven into the gelation bath by a gear conveyor belt for gel precipitation. The temperature of the gelation bath was 10° C., the gelling time was 3 minutes, and the mass percentage of water in the gelation bath was 25%. Next, the above membrane was fed into the extraction tank through a conveyor chain, and the solvent was extracted with water to form a porous separator, the temperature of the extraction tank was 40° C. The porous separator was subjected to forced air drying at a drying temperature of 60° C., and finally sent to a high-temperature setting box at a setting temperature of 250° C. After the static electricity was eliminated, the winding was completed to obtain an aromatic polyamide porous separator, which was washed with clean water and dried at 80° C. A separator with 5 cm in length, 5 cm in width, and 17 μm in thickness was taken and used as the sample, and the sample was measured to have a volume (V) of 4.25×10⁻² cm³, and a weight (W) of 1.642×10⁻² g, which were put into equation to calculate that the porosity (P) of the separator was 72%, and the tensile strength of the separator was measured to be 68 MPa.

### Embodiment 4

50 g of meta aramid was dissolved in 450 g of NMP to form a solution of meta aramid in NMP with a solid content of 10%, the rotational viscosity of which was measured to be 122,000 cp with a viscometer, 2.0 g of nano laponite (Laponite RD powder) and 3.0 g of carboxymethyl cellulose nanofiber powder were added to this solution and then stirred at room temperature for 8 hours to completely disperse the powder in the solution so as to obtain a slurry, and the rotational viscosity of the slurry was measured to be 162,000 cp. The slurry was extruded, and then cast into a gelation bath to form a membrane. Specifically, the slurry was extruded through a die head to form a liquid membrane with a width of 60 cm for the liquid membrane, two edges of the liquid membrane were made into contact with the teflon conveyor chain, with a width of 7.5 cm for teflon conveyor chain and a width of 2.5 cm for the liquid membrane part come into contact with the conveyor chain. The conveyor chain was driven into the gelation bath by a gear conveyor belt for gel precipitation. The temperature of the gelation bath was 10° C., the gelling time was 3 minutes, and the mass percentage of water in the gelation bath was 25%. Next, the above membrane was fed into the extraction tank through a conveyor chain, and the solvent was extracted with water to form a porous separator, the temperature of the extraction tank was 40° C. The porous separator was subjected to forced air drying at a drying temperature of 60° C., and finally sent to a high-temperature setting box at a setting temperature of 250° C. After the static electricity was eliminated, the winding was completed to obtain an aromatic polyamide porous separator, which was washed with clean water and dried at 80° C. A separator with 5 cm in length, 5 cm in width, and 16 μm in thickness was taken for measurement, and the sample was measured to have a volume (V) of 4×10⁻² cm³, and the weight of which was measured to be 0.01104 g, which were put into equation to calculate that the porosity (P) of the separator was 80%, and the tensile strength of the separator was measured to be 70 MPa.

### Embodiment 5

100 g of meta aramid was dissolved in 900 g of DMAC to obtain an aramid solution with a solid content of 10%, the rotational viscosity of this solution was measured to be 118,000 cp with a viscometer, 5.0 g of carboxymethyl cellulose nanofiber powder and 5.0 g of nano laponite (Laponite RD powder) were added to this solution and then stirred for 8 hours to completely disperse the powder in the solution so as to obtain a slurry, and the rotational viscosity of the slurry after the two powders were added was measured to be 165,200 cp. The slurry was extruded, and then cast into a gelation bath to form a membrane. Specifically, the slurry was extruded through a die head to form a liquid membrane with a width of 60 cm for the liquid membrane, two edges of the liquid membrane were made into contact with the teflon conveyor chain, with a width of 7.5 cm for teflon conveyor chain and a width of 2.5 cm for the liquid membrane part come into contact with the conveyor chain. The conveyor chain was driven into the gelation bath by a gear conveyor belt for gel precipitation. The temperature of the gelation bath was 10° C., the gelling time was 3 minutes, and the mass percentage of water in the gelation bath was 25%. Next, the above membrane was fed into the extraction tank through a conveyor chain, and the solvent was extracted with water to form a porous separator, the temperature of the extraction tank was 40° C. The porous separator was subjected to forced air drying at a drying temperature of 60° C., and finally sent to a high-temperature setting box at a setting temperature of 250° C. After the static electricity was eliminated, the winding was completed to obtain an aromatic polyamide porous separator, which was washed with clean water and dried at 80° C. A separator with 5 cm in length, 5 cm in width, and 16 μm in thickness was taken for measurement, and the sample was measured to have a volume (V) of 4×10⁻² cm³, and the weight of the separator was measured to be 0.00828 g, which were put into equation to calculate that the porosity (P) of the separator was 85%, and the tensile strength of the separator was measured to be 80 MPa.

### Embodiment 6

The difference from Embodiment 4 lied in that in Embodiment 6, the nano laponite was 2.5 g, and the carboxymethyl cellulose nanofiber powder was 2.5 g, to finally obtain the separator.

### Embodiment 7

The difference from Embodiment 4 lied in that in Embodiment 7, the nano laponite was 1.7 g, and the carboxymethyl cellulose nanofiber powder was 3.3 g, to finally obtain the separator.

### Embodiment 8

The difference from Embodiment 4 lied in that in Embodiment 8, the nano laponite was 3.3 g, and the carboxymethyl cellulose nanofiber powder was 1.7 g, to finally obtain the separator.

### Embodiment 9

The difference from Embodiment 4 lied in that in Embodiment 9, the nano laponite was 0.45 g, and the carboxymethyl cellulose nanofiber powder was 4.5 g, to finally obtain the separator.

### Embodiment 10

The difference from Embodiment 4 lied in that in Embodiment 10, the nano laponite was 4.5 g, and the carboxymethyl cellulose nanofiber powder was 0.45 g, to finally obtain the separator.

### Embodiment 11

The difference from Embodiment 4 lied in that in Embodiment 11, no nano laponite was added, and the carboxymethyl cellulose nanofiber powder was 5 g, to finally obtain the separator.

### Embodiment 12

The difference from Embodiment 4 lied in that in Embodiment 12, the additive was 5 g of ceramic nanofiber, to finally obtain the separator.

### Embodiment 13

The difference from Embodiment 6 lied in that in Embodiment 13, the amount of meta aramid in the solution was 100 g, NMP was 400 g, and the additive was 5.0 g of nano laponite (Laponite RD powder) and 5.0 g of carboxymethyl cellulose nanofiber powder, to finally obtain the separator.

### Embodiment 14

The difference from Embodiment 6 lied in that in Embodiment 14, the amount of meta aramid in the solution was 75 g, NMP was 425 g, and the additive was 3.75 g of nano laponite (Laponite RD powder) and 3.75 g of carboxymethyl cellulose nanofiber powder, to finally obtain the separator.

### Embodiment 15

The difference from Embodiment 4 lied in that in Embodiment 15, the additive was 1 g of nano laponite (Laponite RD powder) and 1.5 g of carboxymethyl cellulose nanofiber powder, to finally obtain the separator.

### Embodiment 16

The difference from Embodiment 4 lied in that in Embodiment 16, the additive was 0.02 g of nano laponite (Laponite RD powder) and 0.03 g of carboxymethyl cellulose nanofiber powder, to finally obtain the separator.

### Embodiment 17

The difference from Embodiment 4 lied in that in Embodiment 17, the additive was 4 g of nano laponite (Laponite RD powder) and 6 g of carboxymethyl cellulose nanofiber powder, to finally obtain the separator.

### Comparative Embodiment 1

A solution of aramid with a solid content of 20% was formed by dissolving 100 g of meta aramid in 400 g of DMAC, and the rotational viscosity of which was measured to be 152,000 cp with a viscometer. The slurry was extruded, and then cast into a gelation bath (with a gelation bath temperature of 10° C. and a time of 3 minutes) to form a separator. The separator was washed with distilled water and dried at 80° C., a separator sample with 5 cm in length, 5 cm in width, and 20 μm in thickness was taken and the weight of which was measured to be 0.02415 g, which was put into equation to calculate that the porosity (P) of the separator was 65%, and the tensile strength of the separator was measured to be 25 MPa.

Rotational viscosity testing: The rotational viscosity of the slurry was measured using a Brookfield viscometer.

The calculation method for the porosity of the separator: A finished separator with a volume of V was taken and the weight (W) of which was measured, the density of the aramid was known to be ρ (density of meta aramid (φ=1.38 g/cm), and the porosity (P) of the separator was calculated according to the equation P=(1−W/V_{ρ}).

Cell cycle testing: A 5 Ah soft pack lithium battery was used with NCM811 as the positive electrode, graphite as the negative electrode, and lithium hexafluorophosphate as the lithium salt, and tested at the cycle conditions of room temperature (25° C.) 100% DOD, 2C rate, and 500 cycles for comparison, the above test results were shown in Table 1.

TABLE 1

| | | | | | Cycle |
|---|---|---|---|---|---|
| | Previous | Posterior | | | capacity |
| Embodiments/ | rotational | rotational | | Tensile | retention |
| Comparative | viscosity | viscosity | Porosity | strength | rate |
| Embodiments | (cp) | (cp) | (%) | (MPa) | (%) |
| Embodiment 1 | 118,000 | 144,200 | 75 | 28 | 84.7 |
| Embodiment 2 | 122,000 | 145,200 | 78 | 30 | 85.6 |
| Embodiment 3 | 117,500 | 159,700 | 72 | 68 | 88.3 |
| Embodiment 4 | 122,000 | 162,000 | 80 | 70 | 93.1 |
| Embodiment 5 | 118,000 | 165,200 | 85 | 80 | 95.2 |
| Embodiment 6 | 122,000 | 165,200 | 85 | 80 | 95.5 |
| Embodiment 7 | 122,000 | 163,200 | 83 | 78 | 94.5 |
| Embodiment 8 | 122,000 | 161,800 | 84 | 77 | 95.0 |
| Embodiment 9 | 122,000 | 160,000 | 81 | 68 | 92.1 |
| Embodiment 10 | 122,000 | 157,900 | 80 | 67 | 91.8 |
| Embodiment 11 | 122,000 | 159,700 | 78 | 65 | 88.5 |
| Embodiment 12 | 122,000 | 158,700 | 79 | 65 | 89.0 |
| Embodiment 13 | 160,000 | 423,000 | 64 | 85 | 82.3 |
| Embodiment 14 | 135,000 | 324,000 | 73 | 72 | 88.7 |
| Embodiment 15 | 118,000 | 152,000 | 78 | 60 | 90.7 |
| Embodiment 16 | 118,000 | 120,000 | 65 | 27 | 81.5 |
| Embodiment 17 | 118,000 | 160,000 | 77 | 65 | 89.8 |
| Comparative | 152,000 | 152,000 | 65 | 25 | 80.5 |
| Embodiment 1 | | | | | |

The slurry for a separator prepared in Embodiment 6 remained stationary at room temperature for more than 7 days without sedimentation, indicating that the slurry for a separator of this disclosure was relatively stable at room temperature.

From the comparison of Embodiments with comparative Embodiments in Table 1, it could be seen that on the premise of satisfying the basic mechanical strength of the separator, the technical solution of this disclosure achieved the optimal balance between the porosity of the separator and the mechanical strength, ultimately improving the cycle performance of the batteries comprising the separator of this disclosure.

As could be seen from the above description that the above Embodiments of the disclosure achieved the following technical effects:

An additive hydrophilic nanofiber is added to the slurry for a separator, the hydrophilic nanofiber interacts with the aromatic polyamide polymer to form a network-like structure, the interaction between the hydrophilic nanofiber and the aromatic polyamide polymer includes physical and chemical interactions, wherein the physical interaction is manifested as interattraction between positively and negatively charged functional groups, and the chemical interaction is manifested as the formation of hydrogen bonds between molecules. In one aspect, the hydrophilic nanofiber increases the internal tension of the slurry, thereby increasing the mechanical strength of the final separator. On the other hand, the use of the additive of this disclosure can significantly increase the rotational viscosity of the slurry for a separator, which can further reduce the mass fraction of aramid in the slurry while meeting the basic requirements for rotational viscosity in the membrane casting process of the separator. If the mass fraction of aramid decreases, the mass fraction of solvent increases, and the porosity of the separator obtained by non-solvent induced phase separation (NIPS) increases. Therefore, the separator made using the additive in this disclosure can balance high porosity and high mechanical strength, high porosity can further improve the liquid absorption rate and liquid retention rate of the separator, enhancing the cycle life of lithium batteries, while high mechanical strength (characterized by tensile strength) can prevent lithium dendrites from piercing the separator, improving the safety performance of the batteries.

In addition, the addition of a hydrophilic nanofiber can increase the internal tension of aromatic polyamide solutions, so that when the slurry for a separator is extruded and cast through the conveyor into the gelation bath, the upper and lower surfaces can both remain hanged, resulting in a consistent thickness throughout the liquid membrane, and a more uniform pore distribution formed in the process of the gelation bath, and thus the obtained separator is more stable during use.

The above contents only describe the preferred embodiments of the present disclosure, and are not intended to limit the present disclosure. For those skilled in the art, various modifications and changes can be made to the present disclosure. Any modifications, equivalent substitutions, improvements, and the like made within the spirit and principle of the present disclosure shall be included within the scope of protection of the present disclosure.

What is claimed:

1. A slurry for a separator, wherein, the slurry for a separator comprises an aromatic polyamide, a solvent, and an additive, wherein the additive comprises a hydrophilic nanofiber.

2. The slurry for a separator according to claim 1, wherein, in terms of percentage by weight, the slurry for a separator comprises 10 wt % to 20 wt % of the aromatic polyamide and 80 wt % to 90 wt % of the solvent.

3. The slurry for a separator according to claim 2, wherein, the slurry for a separator comprises 10 wt % to 15 wt % of the aromatic polyamide and 85 wt % to 90 wt % of the solvent.

4. The slurry for a separator according to claim 1, wherein, the mass of the hydrophilic nanofiber is 0.1 wt % to 20 wt % of the aromatic polyamide.

5. The slurry for a separator according to claim 4, wherein, the mass of the hydrophilic nanofiber is 5 wt % to 20 wt % of the aromatic polyamide.

6. The slurry for a separator according to claim 4, wherein, the hydrophilic nanofiber is selected from any one or more of a cellulose nanofiber, a ceramic nanofiber, or a glass nanofiber.

7. The slurry for a separator according to claim 6, wherein, the cellulose nanofiber comprises a carboxymethyl cellulose nanofiber.

8. The slurry for a separator according to claim 6, wherein, the ceramic nanofiber is selected from any one or more of an aluminum silicate fiber, a polycrystalline alumina fiber, or a polycrystalline zirconia fiber.

9. The slurry for a separator according to claim 1, wherein, the additive further comprises a hydrophilic nanoparticle with a mass ratio of the hydrophilic nanofiber to the hydrophilic nanoparticle being 1:10 to 10:1.

10. The slurry for a separator according to claim 9, wherein, the mass ratio of the hydrophilic nanofiber to the hydrophilic nanoparticle is 1:2 to 2:1.

11. The slurry for a separator according to claim 9, wherein, the hydrophilic nanoparticle is a flaked silicate and/or gamma alumina powder.

12. The slurry for a separator according to claim 11, wherein, the flaked silicate comprises a nano laponite.

13. The slurry for a separator according to claim 1, wherein, the aromatic polyamide is meta-aramid and/or para-aramid.

14. The slurry for a separator according to claim 1, wherein, the solvent is selected from any one or more of N-methylpyrrolidone, N,N-dimethylacetamide, N,N-dimethylformamide, dimethyl sulfoxide, and triethyl phosphate.

15. The slurry for a separator according to claim 1, wherein, the rotational viscosity of the slurry for a separator is from 100, 000 cp to 500, 000 cp.

16. The slurry for a separator according to claim 15, wherein, the rotational viscosity of the slurry for a separator is from 140, 000 cp to 250, 000 cp.

17. A preparation method for a separator, comprising:
extruding the slurry into a liquid membrane, and sending the liquid membrane into a gelation bath through a conveyor to form a membrane, with the liquid membrane contacted with the conveyor along both sides of the conveying direction;
extracting the solvent from the membrane by a gelation bath to form a porous membrane;
wherein,
the slurry is selected from the slurry for a separator according to claim 1.

18. A separator obtained by the preparation method according to claim 17, wherein, the porosity of the separator is 30% to 90%, preferably 75% to 85%.

19. The separator according to claim 18, wherein, the tensile strength of the separator is from 25 MPa to 85 MPa.
